(19) United States
(12) Patent Application Publication
(10) Pub. No.: US 2015/0331283 A1
(43) Pub. Date: Nov. 19, 2015

(54) DIRECT BACKLIGHT MODULE

(71) Applicant: Shenzhen China Star Optoelectronics Technology Co., Ltd., Shenzhen, Guangdong (CN)

(72) Inventor: Yanxue ZHANG, Shenzhen, Guangdong (CN)

(73) Assignee: Shenzhen China Star Optoelectronics Technology Co., Ltd., Shenzhen, Guangdong (CN)

(21) Appl. No.: 14/371,735

(22) PCT Filed: Jun. 12, 2014
(86) PCT No.: PCT/CN2014/079706

§ 371 Date: Jul. 10, 2014

(30) Foreign Application Priority Data
May 13, 2014 (CN) 201410201576.4

(51) Int. Cl. G02F 1/1335

(52) U.S. Cl. CPC G02F 1/133606; G02F 1/133603; G02F 2001/133628

(57) ABSTRACT

The present invention provides a direct backlight module, which includes: a backlight frame (2), a backlight source (4) mounted in the backlight frame (2), and a diffuser plate (8) mounted on the backlight frame (2) and located above the backlight source (4). The backlight frame (2) includes a bottom frame (22) and a plurality of side boards (24) mounted to outer edges of the bottom frame. The backlight source (4) is mounted on the bottom frame and includes one or multiple high-power LED lights (41). The diffuser plate (8) has a polished surface (82) facing the backlight source (4). The direct backlight module has excellent heat dissipation performance, provides backlighting with homogenized brightness, and reduces the manufacturing cost.

### BACKGROUND OF THE INVENTION

1. Field of the Invention

The present invention relates to the field of liquid crystal displaying, and in particular to a direct backlight module.

2. The Related Arts

Liquid crystal displays (LCDs) have a variety of advantages, such as thin device body, low power consumption, and being free of radiation, and are thus of wide applications. Most of the liquid crystal displays that are currently available in the market are backlighting liquid crystal displays, which comprise a liquid crystal panel and a backlight module. The principle of operation of the liquid crystal panel is that with liquid crystal molecules sandwiched between two parallel glass substrate and a plurality of tiny horizontal and vertical wires arranged between the two glass substrates, application of electricity would control direction change of the liquid crystal molecules in order to refract out light emitting from the backlight module to generate images. Since the liquid crystal panel itself does not emit light, light must be provided from the backlight module in order to normally display images. Thus, the backlight module is one of the key components of the liquid crystal displays. The backlight modules can be classified in two types, namely a side-edge backlight module and a direct backlight module, according to the site where light gets incident. The direct backlight module comprises a light source, such as a cold cathode fluorescent lamp (CCFL) or a light-emitting diode (LED), which is arranged at the backside of the liquid crystal panel and light is allowed to pass through a diffuser plate for homogenization so as to form a planar light source supplied to the liquid crystal panel.

As shown in FIGS. 1 and 2, a known direct backlight module comprises: a backlight frame 100, an LED backlight source 300 mounted in the backlight frame 100, and a diffuser plate 500 that is mounted on the backlight frame 100 and located above the backlight source 300. The LED backlight source 300 is composed of a plurality of LED light bars 301 that is arranged parallel to each other. Each of the LED light bars 301 is mounted to a bottom plate 102 of the backlight frame 100. Each of the LED light bars 301 comprises a plurality of low-power LED lights 303. In other words, the LED backlight source 300 of the direct backlight module comprises a great number of low-power LED lights 303.

Since the LED backlight source take around 40% of the cost of the entire direct backlight module, the backlight source of the above-described known direct backlight module that comprises a large number of LED lights would be of a relatively high expense.

### SUMMARY OF THE INVENTION

An object of the present invention is to provide a direct backlight module, which has excellent heat dissipation performance and provide uniform backlighting brightness and can reduce the manufacturing cost.

To achieve the above object, the present invention provides a direct backlight module, which comprises: a backlight frame, a backlight source mounted in the back frame, and a diffuser plate mounted on the backlight frame and located above the backlight source. The backlight frame comprises a bottom frame and a plurality of side boards mounted to outer edges of the bottom frame. The backlight source is mounted on the bottom frame and comprises one or multiple high-power LED (Light-Emitting Diode) lights. The diffuser plate has a polished surface facing the backlight source.

The backlight source further comprises a PCB (Printed Circuit Board). The high-power LED lights are mounted on the PCB and electrically connected to the PCB. The PCB is mounted to the bottom frame.

The PCB comprises a metal-based printed circuit board and the bottom frame comprises a hollowed section. The PCB is mounted to the bottom frame corresponding to the hollowed section.

The PCB is mounted in the hollowed section of the bottom frame through interference fitting. The high-power LED lights are of a circular configuration and arranged along a transverse center line of the PCB in a uniformly distributed manner.

The PCB comprises an aluminum-based printed circuit board, which is rectangular, and the hollowed section is rectangular.

The polished surface comprises a plurality of polished zones having different degrees of polishing.

The polished surface of the diffuser plate comprises a first polished zone, a second polished zone, and a third polished zone. The first polished zone is located at a central portion of the polished surface and has a polishing degree greater that that of the second polished zone. The second polished zone is located on an outer circumferential area of the first polished zone and has a degree of polishing greater than that of the third polished zone. The third polished zone is located on an outer circumferential area of the second polished zone.

The first polished zone is of an elliptic shape. The second polished zone has a hollowed elliptic shape. The third polished zone has a hollowed rectangular shape.

The first, second, and third polished zones are respectively of degrees of polishing of 90%, 60%, and 15%.

The number of the multiple high-power LED lights is two or three. The high-power LED lights are arranged along a transverse center line of the bottom frame in a uniformly distributed manner.

The present invention also provides a direct backlight module, which comprises: a backlight frame, a backlight source mounted in the back frame, and a diffuser plate mounted on the backlight frame and located above the backlight source, the backlight frame comprising a bottom frame and a plurality of side boards mounted to outer edges of the bottom frame, the backlight source being mounted on the bottom frame comprising one or multiple high-power LED (Light-Emitting Diode)lights, the diffuser plate having a polished surface facing the backlight source;
wherein the backlight source further comprises a PCB (Printed Circuit Board), the high-power LED lights being mounted on the PCB and electrically connected to the PCB, the PCB being mounted to the bottom frame;
wherein the PCB comprises a metal-based printed circuit board and the bottom frame comprises a hollowed section, the PCB being mounted to the bottom frame corresponding to the hollowed section;
wherein the PCB is mounted in the hollowed section of the bottom frame through interference fitting, the high-power LED lights being of a circular configuration and arranged along a transverse center line of the PCB in a uniformly distributed manner;
wherein the PCB comprises an aluminum-based printed circuit board, which is rectangular, and the hollowed section is rectangular; and
wherein the high-power LED lights are arranged along a transverse center line of the bottom frame in a uniformly distributed manner.

The polished surface comprises a plurality of polished zones having different degrees of polishing.

The polished surface of the diffuser plate comprises a first polished zone, a second polished zone, and a third polished zone. The first polished zone is located at a central portion of the polished surface and has a polishing degree greater that that of the second polished zone. The second polished zone is located on an outer circumferential area of the first polished zone and has a degree of polishing greater than that of the third polished zone. The third polished zone is located on an outer circumferential area of the second polished zone.

The first polished zone is of an elliptic shape. The second polished zone has a hollowed elliptic shape. The third polished zone has a hollowed rectangular shape.

The first, second, and third polished zones are respectively of degrees of polishing of 90%, 60%, and 15%.

The efficacy of the present invention is that the present invention provides a direct backlight module, which comprises a backlight frame in which a backlight source comprises one or multiple high-power LED lights is mounted in such a way that a metal-based PCB of the backlight source is mounted in a hollowed section of a bottom plate of the backlight frame and a diffuser plate is provided with a polished surface formed on a surface thereof facing the backlight source and provided with a plurality of zones having different degrees of polishing so as to provide an excellent heat dissipation performance, ensure homogenization of brightness of the backlighting provided, and reduce the manufacturing cost.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view showing the structure of a conventional direct backlight module;

FIG. 2 is a cross-sectional view taken along line A-A of FIG. 1;

FIG. 3 is a schematic view showing the structure of a direct backlight module according to the present invention;

FIG. 4 is a cross-sectional view taken along line B-B of FIG. 3; and

FIG. 5 is a schematic view showing a polished surface of a diffuser plate of the direct backlight module according to the present invention.

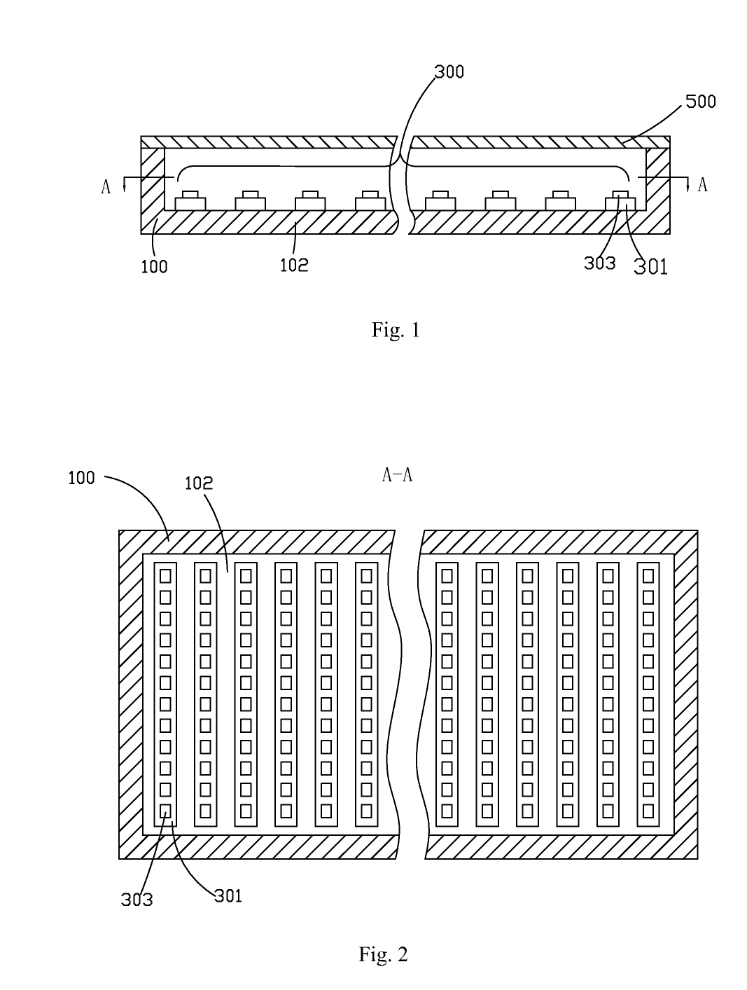

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

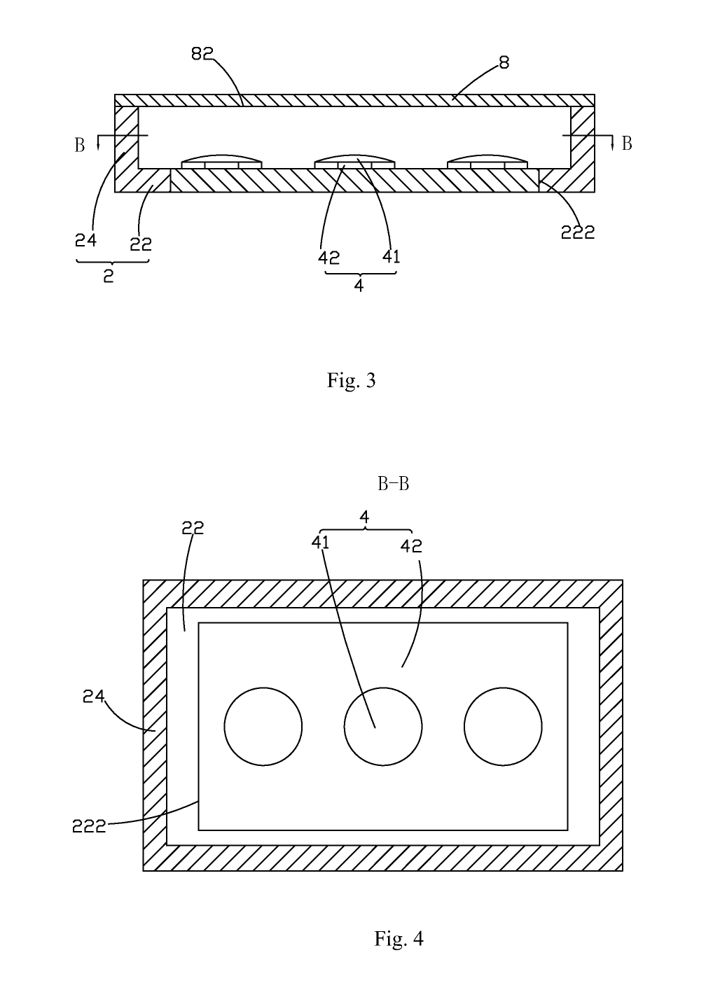

Referring to FIGS. 3 and 4, the present invention provides a direct backlight module, which comprises: a backlight frame 2, a backlight source 4 mounted in the back frame 2, and a diffuser plate 8 mounted on the backlight frame 2 and located above the backlight source 4. The backlight frame 2 carries and supports the backlight source 4 and the diffuser plate 8. The backlight source 4 supplies light, which is homogenized by the diffuser plate 8 to form a planar light source supplied to a liquid crystal panel.

The backlight source 4 comprises a PCB (Printed Circuit Board) 42 and one or multiple high-power LED lights 41 mounted on the PCB 42 and electrically connected to the PCB 42. An advantage of adopting the described backlight source 4 is that one or multiple high-power LED lights 41, even a just small number, can suit the need for providing a planar light source to the liquid crystal panel so as to reduce the overall manufacturing cost of the entire direct backlight module and also facilitate subsequent assembling operations.

The one or multiple high-power LED lights 41 can be of a rectangular configuration or a circular configuration. Preferably, the high-power LED lights 41 are of a circular configuration. When there is only one high-power LED light 41, the single high-power LED light 41 is arranged at a center of the PCB 42; and where there are two or three high-power LED lights 41, they are arranged along a transverse center line of the PCB 42 in a uniformly distributed manner.

The PCB 42 can be rectangular or circular and preferably, the PCB 42 is rectangular. The PCB 42 can be a metal-based printed circuit board and preferably, the PCB 42 is an aluminum-based printed circuit board. Since aluminum has high thermal conductivity, heat generated during the operation of the backlight source 4 can be dissipated as quickly as possible.

The backlight frame 2 comprises a bottom frame 22 and a plurality of side boards 24 mounted to outer edges of the bottom frame 22. The bottom frame 22 comprises a hollowed section 222 corresponding to the PCB 42 of the backlight source 4. Preferably, the hollowed section 222 is rectangular and is symmetric about a center of the bottom frame 22.

The backlight source 4 is mounted on the bottom frame 22. Specifically, the PCB 42 of the backlight source 4 is mounted in the hollowed section 222 of the bottom frame 22 through interference fitting so as to mount the backlight source 4 in the backlight frame 2. A single one high-power LED light 41 is located at the center of the bottom frame 22; and multiple high-power LED lights 41 are arranged along a transverse center line of the bottom frame 22 in a uniformly distributed manner.

Since the PCB 42 of the backlight source 4 is an aluminum-based printed circuit board and is located in the hollowed section 222 of the bottom frame 22, the bottom frame 22 does not constitute a barrier to the backlight source 4 so that the heat generated during the operation of the backlight source 4 can be efficiently dissipated through the PCB 42, providing the direct backlight module with excellent heat dissipation performance.

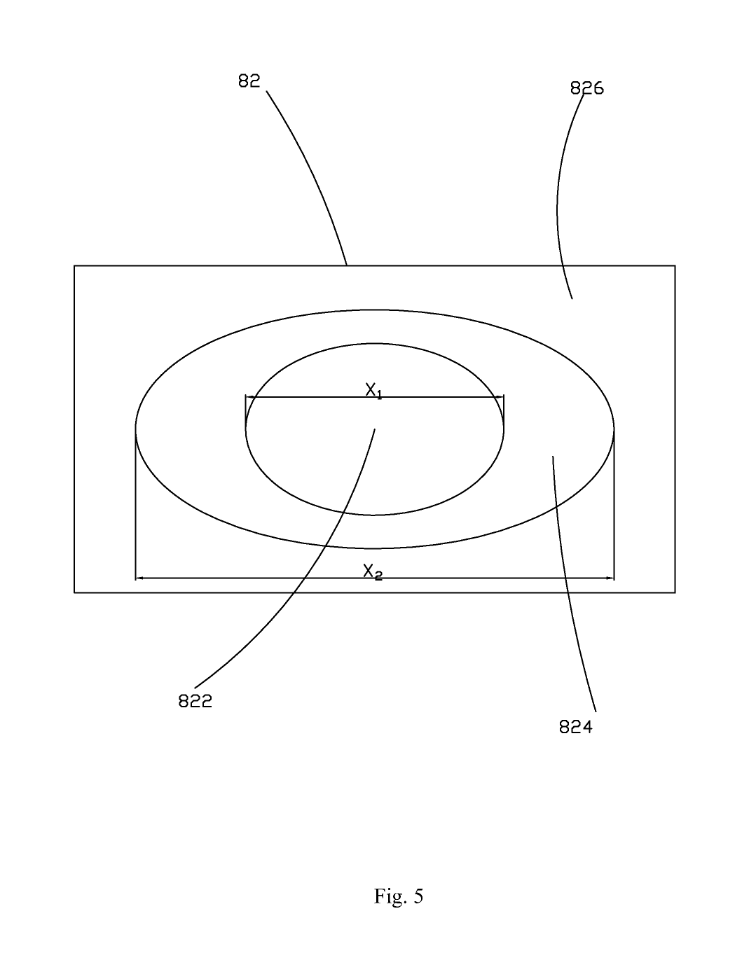

The diffuser plate 8 has a surface that faces the backlight source 4 and is a polished surface 82. Referring to FIG. 5, the polished surface 82 comprises multiple polished zones having different degrees of polishing, which are respectively a first polished zone 822, a second polished zone 824, and a third polished zone 826. The first polished zone 822 is located at a central portion of the polished surface 82 and has a polishing degree greater that that of the second polished zone 824; the second polished zone 824 is located on an outer circumferential area of the first polished zone 822 and has a degree of polishing greater than that of the third polished zone 826; and the third polished zone 826 is located on an outer circumferential area of the second polished zone 824. Preferably, the first polished zone 822 is of an elliptic shape and the ellipse has a major axis X₁ that extends in the direction in which the multiple high-power LED lights are distributed with the increase of the number of the high-power LED lights. The second polished zone 824 has a hollowed elliptic shape and the ellipse has a X₂ that also extends in the direction in which the multiple high-power LED lights are distributed with the increase of the number of the high-power LED lights. The third polished zone 82 has a hollowed rectangular shape. The first, second, and third polished zones 822, 824, 826 are respectively of degrees of polishing of 90%, 60%, and 15%. The shapes, ranges, and degrees of polishing of the first, second, and third polished zones 822, 824, 826 can be adjusted according to a specific arrangement of the backlight source 4.

Light emitting from the backlight source 4 would get concentrated toward the central portion of the diffuser plate 8 and get increasingly dimmed toward the outer circumference of the diffuser plate 8. Since the diffuser plate 8 is composed of the first, second, and third polished zones 822, 824, 826 that are sequentially arranged from the central portion toward the outer circumference thereof respectively, having increasingly reduced degrees of surface fineness and having increasingly reduced capability of reflecting light back to the bottom frame 22, the capability of dispersing light being increasingly enhanced to eventually achieve better homogenization of the light passing through the diffuser plate 8.

In summary, the present invention provides a direct backlight module, which comprises a backlight frame in which a backlight source comprises one or multiple high-power LED lights is mounted in such a way that a metal-based PCB of the backlight source is mounted in a hollowed section of a bottom plate of the backlight frame and a diffuser plate is provided with a polished surface formed on a surface thereof facing the backlight source and provided with a plurality of zones having different degrees of polishing so as to provide an excellent heat dissipation performance, ensure homogenization of brightness of the backlighting provided, and reduce the manufacturing cost.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A direct backlight module, comprising: a backlight frame, a backlight source mounted in the back frame, and a diffuser plate mounted on the backlight frame and located above the backlight source, the backlight frame comprising a bottom frame and a plurality of side boards mounted to outer edges of the bottom frame, the backlight source being mounted on the bottom frame and comprising one or multiple high-power LED (Light-Emitting Diode) lights, the diffuser plate having a polished surface facing the backlight source.

2. The direct backlight module as claimed in claim 1, wherein the backlight source further comprises a PCB (Printed Circuit Board), the high-power LED lights being mounted on the PCB and electrically connected to the PCB, the PCB being mounted to the bottom frame.

3. The direct backlight module as claimed in claim 2, wherein the PCB comprises a metal-based printed circuit board and the bottom frame comprises a hollowed section, the PCB being mounted to the bottom frame corresponding to the hollowed section.

4. The direct backlight module as claimed in claim 3, wherein the PCB is mounted in the hollowed section of the bottom frame through interference fitting, the high-power LED lights being of a circular configuration and arranged along a transverse center line of the PCB in a uniformly distributed manner.

5. The direct backlight module as claimed in claim 4, wherein the PCB comprises an aluminum-based printed circuit board, which is rectangular, and the hollowed section is rectangular.

6. The direct backlight module as claimed in claim 1, wherein the polished surface comprises a plurality of polished zones having different degrees of polishing.

7. The direct backlight module as claimed in claim 6, wherein the polished surface of the diffuser plate comprises a first polished zone, a second polished zone, and a third polished zone, the first polished zone being located at a central portion of the polished surface and having a polishing degree greater that that of the second polished zone, the second polished zone being located on an outer circumferential area of the first polished zone and having a degree of polishing greater than that of the third polished zone, the third polished zone being located on an outer circumferential area of the second polished zone.

8. The direct backlight module as claimed in claim 7, wherein the first polished zone is of an elliptic shape, the second polished zone having a hollowed elliptic shape, the third polished zone having a hollowed rectangular shape.

9. The direct backlight module as claimed in claim 8, wherein the first, second, and third polished zones are respectively of degrees of polishing of 90%, 60%, and 15%.

10. The direct backlight module as claimed in claim 1, wherein the number of the multiple high-power LED lights is two or three, the high-power LED lights being arranged along a transverse center line of the bottom frame in a uniformly distributed manner.

11. A direct backlight module, comprising: a backlight frame, a backlight source mounted in the back frame, and a diffuser plate mounted on the backlight frame and located above the backlight source, the backlight frame comprising a bottom frame and a plurality of side boards mounted to outer edges of the bottom frame, the backlight source being mounted on the bottom frame and comprising one or multiple high-power LED (Light-Emitting Diode) lights, the diffuser plate having a polished surface facing the backlight source;
wherein the backlight source further comprises a PCB (Printed Circuit Board), the high-power LED lights being mounted on the PCB and electrically connected to the PCB, the PCB being mounted to the bottom frame;
wherein the PCB comprises a metal-based printed circuit board and the bottom frame comprises a hollowed section, the PCB being mounted to the bottom frame corresponding to the hollowed section;
wherein the PCB is mounted in the hollowed section of the bottom frame through interference fitting, the high-power LED lights being of a circular configuration and arranged along a transverse center line of the PCB in a uniformly distributed manner;
wherein the PCB comprises an aluminum-based printed circuit board, which is rectangular, and the hollowed section is rectangular; and
wherein the high-power LED lights are arranged along a transverse center line of the bottom frame in a uniformly distributed manner.

12. The direct backlight module as claimed in claim 11, wherein the polished surface comprises a plurality of polished zones having different degrees of polishing.

13. The direct backlight module as claimed in claim 12, wherein the polished surface of the diffuser plate comprises a first polished zone, a second polished zone, and a third polished zone, the first polished zone being located at a central portion of the polished surface and having a polishing degree greater that that of the second polished zone, the second polished zone being located on an outer circumferential area of the first polished zone and having a degree of polishing greater than that of the third polished zone, the third polished zone being located on an outer circumferential area of the second polished zone.

14. The direct backlight module as claimed in claim 13, wherein the first polished zone is of an elliptic shape, the second polished zone having a hollowed elliptic shape, the third polished zone having a hollowed rectangular shape.

15. The direct backlight module as claimed in claim 14, wherein the first, second, and third polished zones are respectively of degrees of polishing of 90%, 60%, and 15%.
